(19) United States
(12) Patent Application Publication
(10) Pub. No.: US 2025/0097357 A1
(43) Pub. Date: Mar. 20, 2025

(54) IMAGE PROCESSING SYSTEM, NON-TRANSITORY COMPUTER READABLE MEDIUM STORING PROGRAM, AND IMAGE PROCESSING METHOD

(71) Applicant: FUJIFILM Business Innovation Corp., Tokyo (JP)

(72) Inventors: Manabu HAYASHI, Kanagawa (JP); Takashi MURAKAMI, Kanagawa (JP)

(73) Assignee: FUJIFILM Business Innovation Corp., Tokyo (JP)

(21) Appl. No.: 18/593,987

(22) Filed: Mar. 4, 2024

(30) Foreign Application Priority Data
Sep. 14, 2023 (JP) 2023-149453

(51) Int. Cl. H04N 1/00; G06T 7/00

(52) U.S. Cl. CPC H04N 1/00413; G06T 7/0002; H04N 1/0044; H04N 1/00811; H04N 1/00816; G06T 2200/24; G06T 2207/30144

(57) ABSTRACT

An image processing system includes an imaging unit, and a processor, in which the processor is configured to display a list of reading attributes set in a case where a read image of an original document is generated in response to a user operation, specify, as a preview region, a partial region on the original document that is a generation range of a preview image of the original document in a case where one reading attribute is selected from the list of reading attributes by a user, generate the preview image corresponding to the preview region for each attribute value obtainable for the one reading attribute from a captured image of the original document captured by the imaging unit, display an attribute value selection screen showing an association between each attribute value obtainable for the one reading attribute and the preview image generated in accordance with the attribute value, and set an attribute value selected from the attribute value selection screen by the user as an attribute value of the one reading attribute in a case where the read image of the original document is generated.

### CROSS-REFERENCE TO RELATED APPLICATIONS

This application is based on and claims priority under 35 USC 119 from Japanese Patent Application No. 2023-149453 filed Sep. 14, 2023.

### BACKGROUND

### (i) Technical Field

The present invention relates to an image processing system, a non-transitory computer readable medium storing a program, and an image processing method.

### (ii) Related Art

In a case where an original document is scanned to generate a read image, various reading attributes such as a color mode and a resolution can be generally set. Therefore, there is a case where a user wants to check whether or not the appropriateness/inappropriateness of a setting of an attribute value of the reading attribute before the user generates and saves the read image of the original document. In this case, the user can check in advance what kind of read image is created by major scanning by generating a preview image before the read image of the original document is officially generated by the major scanning.

For example, in JP2008-252537A, a plurality of patterns of scan setting data are generated by combining selection candidates for a setting value in each setting item such as a resolution, a color, or a data format, a preview image corresponding to each scan setting data is generated by pre-scanning an original document, and the preview image is provided to a user. The user can check the appropriateness/inappropriateness of the combination of the setting values in each setting item by viewing the preview image corresponding to each scan setting data.

### SUMMARY

However, in the related art, in a case where there are many selection candidates for the attribute value in each reading attribute of the original document, the number of preview images provided is increased. In this case, the user has to search for the preview image generated by a combination of intended attribute values from a large number of preview images. Therefore, it is difficult to efficiently search for the attribute value of the reading attribute set in the generation of the read image of the original document.

Aspects of non-limiting embodiments of the present disclosure relate to an image processing system, a non-transitory computer readable medium storing a program, and an image processing method that, in a case where a user checks the appropriateness/inappropriateness of a setting of an attribute value of a reading attribute by a preview image before a read image of an original document is generated, can more efficiently set the attribute value of the reading attribute than in a case where a plurality of preview images are generated by combining the attribute values of the reading attribute used by the user as selection candidates.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing system including an imaging unit, and a processor, in which the processor is configured to display a list of reading attributes set in a case where a read image of an original document is generated in response to a user operation, specify, as a preview region, a partial region on the original document that is a generation range of a preview image of the original document in a case where one reading attribute is selected from the list of reading attributes by a user, generate the preview image corresponding to the preview region for each attribute value obtainable for the one reading attribute from a captured image of the original document captured by the imaging unit, display an attribute value selection screen showing an association between each attribute value obtainable for the one reading attribute and the preview image generated in accordance with the attribute value, and set an attribute value selected from the attribute value selection screen by the user as an attribute value of the one reading attribute in a case where the read image of the original document is generated.

### BRIEF DESCRIPTION OF THE DRAWINGS

Exemplary embodiment(s) of the present invention will be described in detail based on the following figures, wherein:

FIG. 1 is a block configuration diagram of a multifunction machine that forms an image processing system in the present exemplary embodiment;

FIG. 2 is a schematic perspective view of the multifunction machine in the present exemplary embodiment;

FIG. 3 is a hardware configuration diagram of a multifunction machine in the present exemplary embodiment;

FIG. 4 is a diagram showing an example of a data configuration of preview region setting information stored in a preview region setting information storage unit in the present exemplary embodiment;

FIG. 5 is a flowchart showing reading attribute setting processing in the present exemplary embodiment;

FIG. 6 is a diagram showing a display example of an attribute value selection screen in the present exemplary embodiment; and

FIG. 7 is a diagram showing a part of a preview image for each attribute value in an enlarged manner in the present exemplary embodiment.

### DETAILED DESCRIPTION

Hereinafter, an exemplary embodiment of the present invention will be described with reference to the drawings.

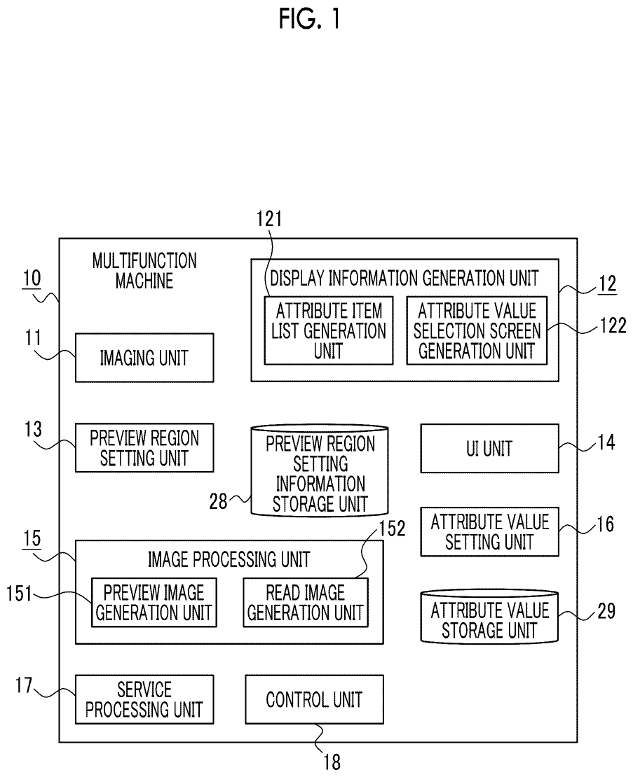

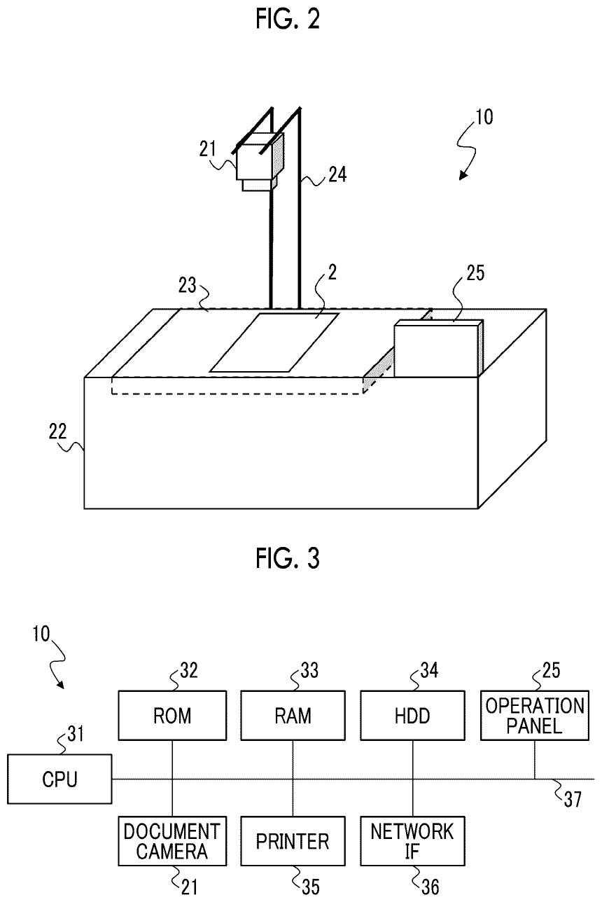

FIG. 1 is a block configuration diagram of a multifunction machine 10 that forms an image processing system according to an exemplary embodiment of the present invention. FIG. 2 is a schematic perspective view of the multifunction machine 10 in the present exemplary embodiment, and FIG. 3 is a hardware configuration diagram of the multifunction machine 10 in the present exemplary embodiment.

The multifunction machine 10 in the present exemplary embodiment is characterized in that, as the apparatus configuration, a document camera 21 is mounted as shown in FIG. 2. The multifunction machine 10 is provided with an original document table 23 on an upper surface of an apparatus body 22, and the document camera 21 that sets a range in which the entire original document table 23 can be imaged. The document camera 21 is supported by a support rod 24. Further, an operation panel 25 that functions as an input unit operated by a user and as a display unit that displays information is provided on the upper surface of the apparatus body 22.

The multifunction machine 10 in the present exemplary embodiment is an image forming apparatus having various functions such as a printing function, a copying function, and a scanning function, and is an apparatus in which a computer is built in. That is, as shown in FIG. 3, the multifunction machine 10 includes a CPU 31, a ROM 32, a RAM 33, a hard disk drive (HDD) 34 as a storage unit, the operation panel 25 as a user interface, the document camera 21 as an imaging unit, a printer 35 that provides a printing function, and a network interface (IF) 36 as a communication unit. An address data bus 37 connects the various mechanisms 31 to 36, 21, and 25 that are control targets by the CPU 31 and performs data communication.

Incidentally, in a multifunction machine that has been known in the related art generally, a scanner that optically reads an original document 2 on the original document table 23 in order to realize a scanning function is mounted. In the multifunction machine 10 in the present exemplary embodiment, the document camera 21 is mounted instead of the scanner. Therefore, a read image of the original document 2 is generated by a captured image obtained by imaging with the document camera 21 or by performing image processing on the captured image. Although the document camera 21 generates the captured image of the original document 2 by capturing the original document 2 on the original document table 23, it can be said that the original document 2 is read by capturing the original document 2, and thus the terms “capture” and “read” are used synonymously without strict distinction in the present exemplary embodiment. Therefore, “captured” by the document camera 21 may be referred to as “read” or “scanned” by replacing the “captured” by the document camera 21 with “read”.

As shown in FIG. 1, the multifunction machine 10 in the present exemplary embodiment includes an imaging unit 11, a display information generation unit 12, a preview region setting unit 13, a user interface (UI) unit 14, an image processing unit 15, an attribute value setting unit 16, a service processing unit 17, a control unit 18, a preview region setting information storage unit 28, and an attribute value storage unit 29. The components that are not used in the description in the present exemplary embodiment are omitted from the drawings.

The imaging unit 11 is realized by the document camera 21 and images the entire upper surface of the original document table 23 as an imaging range. The display information generation unit 12 generates display information to be displayed on the operation panel 25. The display information generation unit 12 includes an attribute item list generation unit 121 and an attribute value selection screen generation unit 122. The attribute item list generation unit 121 generates a list of reading attributes of the read image of the original document (hereinafter, also referred to as an “attribute item list”) as the display information. The attribute item list includes items of attributes that can be set by the user in a case where the read image of the original document is generated. Various attributes are set for the read image of the original document. Obtainable attribute values are determined in advance for each attribute item, and the attribute value is set by being selected by the user from the obtainable attribute values, or a numerical value or the like is designated and determined by the user. In the present exemplary embodiment, among the attribute items set for the read image of the original document, the attribute item used to generate the read image of the original document is referred to as a “reading attribute”. In the present exemplary embodiment, since the focus is on the read image, the “attribute item” and the “reading attribute” are used synonymously. Incidentally, examples of the attribute item that does not correspond to the reading attribute include the creation date and time or the creator, and examples of the attribute item corresponding to the reading attribute include a resolution or sharpness related to an image quality, a file format in a case of saving a read image, a color mode, a frame erasure, and a reading size. As the reading attribute, an item of a general attribute that has been used in the related art may be used. The attribute value selection screen generation unit 122 generates an attribute value selection screen (to be described later) as the display information.

The preview region setting unit 13 sets a generation range of a preview image in the captured image of the original document captured by the document camera 21, as a preview region. The preview region setting unit 13 in the present exemplary embodiment sets the preview region with reference to preview region setting information.

The user interface unit 14 is realized by the operation panel 25 and displays a screen or the like of various menus in the multifunction machine 10. The user interface unit 14 receives a user operation on the displayed screen.

The image processing unit 15 executes image processing on the captured image by the document camera 21 as a processing target. The image processing unit 15 includes a preview image generation unit 151 and a read image generation unit 152. The preview image generation unit 151 generates a preview image based on a predetermined reading attribute. The predetermined reading attribute is an attribute value set by the user or an initial value, but details will be described later. The read image generation unit 152 generates the read image of the original document in accordance with the attribute value of each reading attribute set by the user from the captured image obtained by the document camera 21. Since the document camera 21 captures the entire upper surface of the original document table 23 as the imaging range, the captured image of the original document 2 is obtained by extracting the imaging range of the original document 2 from the captured image by the document camera 21. The read image generation unit 152 generates the read image of the original document 2 by performing image processing required for the captured image of the original document 2, as will be described later.

The attribute value setting unit 16 sets the attribute value selected by the user in the reading attribute selected by the user from the attribute value selection screen as the attribute value of the reading attribute. The set attribute value is saved in the attribute value storage unit 29 in association with the reading attribute. The service processing unit 17 realizes a service designated by the user by using the read image of the original document generated by the read image generation unit 152. A service provided to the user by the multifunction machine 10 includes a transmission service for transmitting the read image of the original document to a designated address. The control unit 18 controls the operations of each of the components 11 to 17.

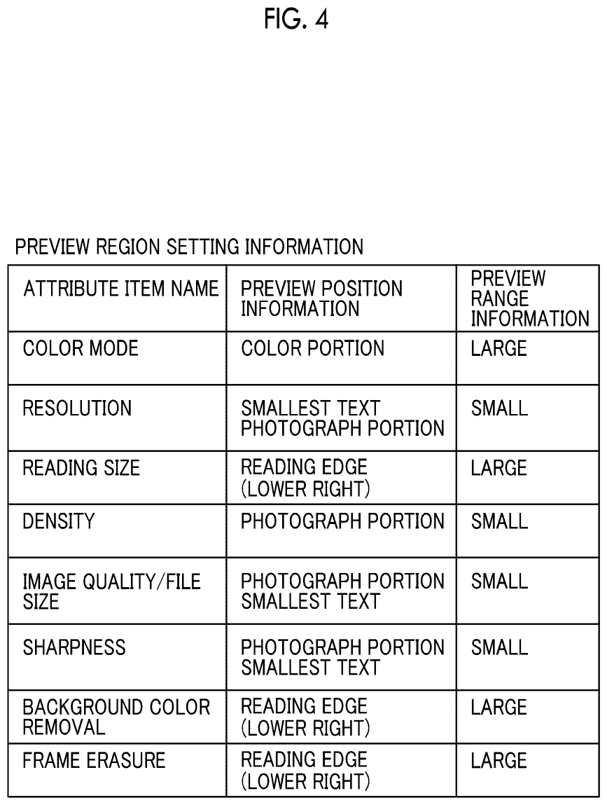

FIG. 4 is a diagram showing an example of a data configuration of the preview region setting information stored in the preview region setting information storage unit 28 in the present exemplary embodiment. The preview region setting unit 13 sets the preview region to an initial setting with reference to the preview region setting information. Therefore, the preview region setting information needs to be set in the preview region setting information storage unit 28 before the provision of the service processing is started.

The preview region setting information is set such that preview position information and preview range information are associated with an attribute item name that is a name of the reading attribute. In the preview position information, a position at which a difference in the attribute value obtainable for the corresponding reading attribute is easily visible is set. For example, in a case where the resolution of the read image is low, the difference in the resolution is easily visible in small text, a photograph portion, and particularly a boundary line and a hatched portion of the photograph. As shown in FIG. 4, the setting as the preview position information is not limited to the information in which the position such as the coordinate data is specified. In the preview range information, a range for generating an image (that is, a preview image) in which the difference in the attribute value obtainable for the corresponding reading attribute is easily visible is set. In the present exemplary embodiment, an example is shown in which the range is set to a square shape for convenience and a default size is set to two stages of “large” (for example, 4 cm square) and “small” (for example, 1 cm square). Of course, the present exemplary embodiment is not limited to this. For example, the shape of the preview region does not need to be limited to a square shape, and the size may be set in more stages. In addition, the setting may be made by a numerical value.

Each of the components 11 to 18 in the multifunction machine 10 is realized by a cooperative operation of the computer mounted on the multifunction machine 10 and a program operated by the CPU 31 mounted on the computer. In addition, each of the storage units 28 and 29 is realized by the HDD 34 mounted on the multifunction machine 10. Alternatively, the RAM 33 or an external storage unit may be used via a network.

Further, the program used in the present exemplary embodiment may be not only provided by a communication unit but also provided by storing the program in a computer readable recording medium such as a USB memory. The program provided from the communication unit or the recording medium is installed in the computer, and various types of processing are realized by sequentially executing the program by the CPU 31 of the computer.

In addition, the multifunction machine 10 constituting the image processing system is shown as a single apparatus, but may be realized by combining a plurality of computers or apparatuses. For example, the multifunction machine 10 may perform the image processing, and the user interface may use another information processing apparatus such as a PC.

Hereinafter, an operation of the present exemplary embodiment will be described.

In a case where the user uses an intended service in which the original document is scanned by the multifunction machine 10, the user logs in to the multifunction machine 10 and performs an operation of selecting the intended service from a home screen or the like displayed on the operation panel 25. The document camera 21 starts imaging at a constant time interval in response to the user operation. The imaging by the document camera 21 is referred to as “pre-scanning” because the imaging is started after the selection of the service and before the user gives an instruction to scan the original document 2. On the other hand, the scanning performed to obtain the read image of the original document 2 in response to the execution instruction for the service or the scanning instruction from the user is referred to as “major scanning”.

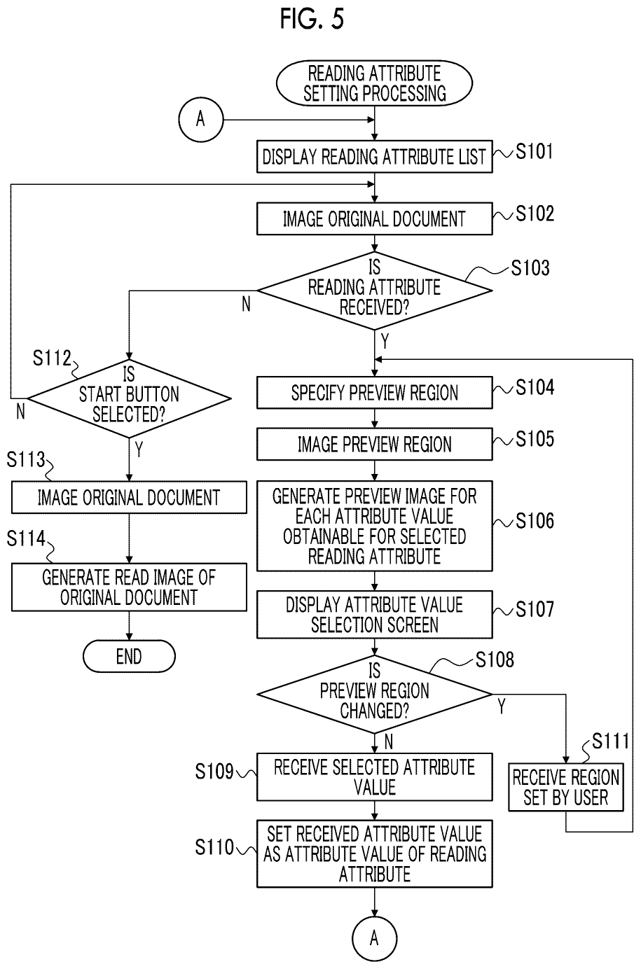

The user places the original document 2 on the original document table 23 before or after the selection of the service. In this case, the user places the original document 2 such that a printing surface to be read by the document camera 21 faces upward. Here, it is assumed that the user uses one original document 2 to use the service. Hereinafter, the reading attribute setting processing of the original document 2 in the present exemplary embodiment will be described with reference to the flowchart shown in FIG. 5.

As described above, in a case where the user selects the service that requires scanning of the original document from the home screen or the like, the imaging unit 11 starts the imaging of the original document 2 on the original document table 23 by using the document camera 21 at the constant time interval in response to this user operation.

In addition, the attribute item list generation unit 121 generates the attribute item list in response to the user operation such as the selection of the service. The user operation that triggers the generation of the attribute item list is not limited to this, and may be an operation such as the user login or the placement of the original document 2 on the original document table 23. In addition, the reading attributes that can be set for the original document 2 and the attribute values obtainable for the reading attribute or the range of the attribute values are known information depending on the specifications of the multifunction machine 10. The attribute item list generation unit 121 acquires the item name of the reading attribute included in the information such as the specification from a predetermined storage destination.

Subsequently, in a case where the attribute item list is generated, the display information generation unit 12 displays the attribute item list on the user interface unit 14, that is, the operation panel 25 (step S101).

As described above, the document camera 21, that is, the imaging unit 11 that starts the imaging performs the imaging at the constant time interval, but since it is necessary to image the original document 2 on the original document table 23 to obtain the captured image of the original document 2, the processing of imaging the original document 2 is clearly indicated in the flowchart (step S102).

In a case where one reading attribute to be checked in advance by the user is selected from the displayed attribute item list, the user interface unit 14 receives the selected reading attribute. In this case (Y in step S103), the preview region setting unit 13 specifies the preview region on the captured image of the original document 2 with reference to the preview region setting information corresponding to the reading attribute selected by the user (step S104). In a case where the preview region is specified, the imaging unit 11 images at least the preview region of the original document 2 (step S105).

Subsequently, the preview image generation unit 151 of the image processing unit 15 generates the preview image for each attribute value obtainable for the reading attribute selected by the user from the image included in the preview region in the captured image of the original document 2 (step S106). For example, it is assumed that the user selects “resolution” as the reading attribute from the attribute item list. In addition, it is assumed that the multifunction machine 10 can obtain four attribute values of 200 dpi, 300 dpi, 400 dpi, and 600 dpi as the resolution. In this case, the preview image generation unit 151 generates the preview image corresponding to each of the attribute values of 200 dpi, 300 dpi, 400 dpi, and 600 dpi. There are two types of methods for generating the preview image.

One pattern is imaged once by the document camera 21 by using one attribute value among the obtainable attribute values. In this case, for example, it is desired to perform the imaging with the highest accuracy of 600 dpi in terms of the accuracy of the image processing. The preview image generation unit 151 generates the preview image corresponding to each of the attribute values of 200 dpi, 300 dpi, 400 dpi, and 600 dpi by performing the image processing on the captured image having the resolution of 600 dpi. The resolution of the captured image as the original data of the image processing is 600 dpi, and thus it may be said that image processing of generating the preview image at 600 dpi is not necessary. However, it is necessary to perform image processing of cutting out and extracting an image in the preview region from the captured image of the document camera 21. In this pattern, the document camera 21 may be caused to perform the imaging only once to obtain one captured image. The imaging for obtaining the one captured image may be performed using the captured image generated by the imaging in step S102 without being performed separately in step S105.

The other is that in a case where the document camera 21 can generate the captured image in accordance with the attribute value obtainable for the one reading attribute, such as “resolution” shown here, the document camera 21 generates the captured image corresponding to the attribute value. That is, the document camera 21 is caused to perform the imaging based on the attribute value obtainable for the resolution, that is, each of the attribute values of 200 dpi, 300 dpi, 400 dpi, and 600 dpi. The preview image generation unit 151 generates the preview image corresponding to each attribute value by image processing of cutting out and extracting the image in the preview region from the captured image. As will be described later, the document camera 21 cannot perform the imaging in a state where, for example, a frame is erased. Therefore, the reading attribute of “frame erasure” corresponds to the reading attribute that cannot generate the captured image in accordance with the obtainable attribute value, and the imaging described above is performed only once, and then the image processing is performed in accordance with the frame erasure amount (size from the edge of the paper) as the attribute value.

As described above, in a case where the preview image is generated for each attribute value obtainable for the reading attribute selected by the user, the attribute value selection screen generation unit 122 of the display information generation unit 12 generates the attribute value selection screen. The display information generation unit 12 displays the attribute value selection screen 40 generated by the attribute value selection screen generation unit 122 on the operation panel 25 (step S107).

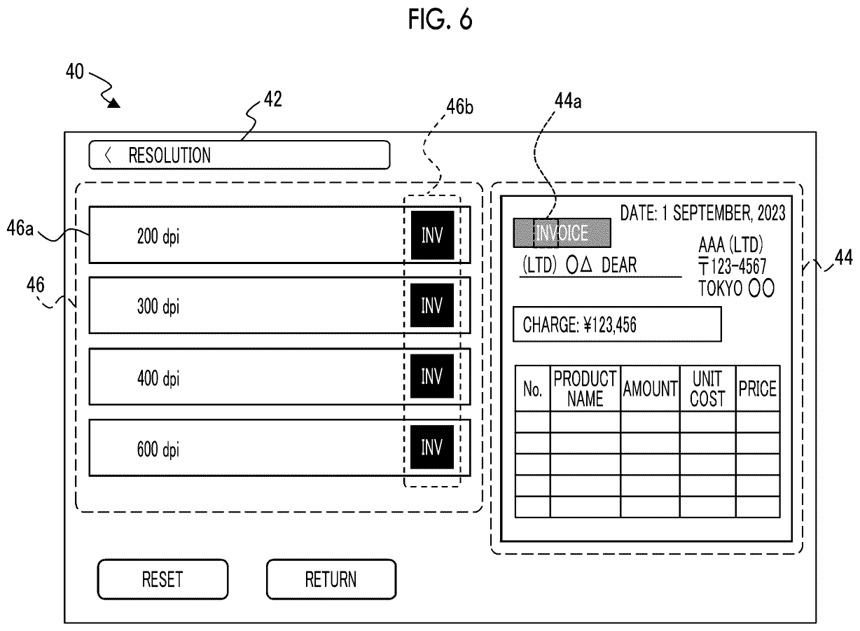

FIG. 6 is a diagram showing a display example of the attribute value selection screen 40 in the present exemplary embodiment. The attribute value selection screen 40 shown in FIG. 6 is a screen display example in a case where the user selects the reading attribute of “resolution” from the attribute item list. A reading attribute display region 42, an original document image display region 44, and a preview image display region 46 are provided on the attribute value selection screen 40.

One reading attribute selected by the user from the attribute item list is displayed in the reading attribute display region 42. The captured image of the original document 2 is displayed in the original document image display region 44. The displayed captured image of the original document 2 may be sequentially updated with the captured image generated by the imaging at each constant time interval and used as the latest captured image, and for example, the captured image generated in step S101 and step S105 may be displayed. In addition, a preview region 44a set at the current point in time is shown by a broken line such that the setting position and the size can be understood on the captured image of the original document 2. As described above, the original document image display region 44 included in the attribute value selection screen 40 functions as a preview region check screen indicating the position of the preview region 44a on the captured image of the original document 2.

In the preview image display region 46, the attribute value obtainable for the reading attribute selected by the user and a preview image 46b generated by the preview image generation unit 151 using the attribute value are displayed as a set. In the present exemplary embodiment, the set is clearly indicated by a frame 46a. The display example shown in FIG. 6 shows that the multifunction machine 10 can obtain four attribute values of 200 dpi, 300 dpi, 400 dpi, and 600 dpi as the resolution.

In a case where the reading attribute is “resolution”, the preview region setting unit 13 specifies “smallest text” or “photograph portion” as the preview region with reference to the preview region setting information shown in FIG. 4, and cuts out “small”, that is, a default small area from the captured image as the preview region. More specifically, in a case of attempting to set a range including the smallest text as the preview region, the preview region setting unit 13 extracts the text by performing text analysis on the captured image of the original document 2, searches for the text having the minimum text size, and sets the preview region. However, although details will be described later, the setting of the position and the size of the preview region may be changed by the user. FIG. 6 shows, for convenience of description, a case where the text size is not the minimum and the user sets a range including the text of “inv” of “invoice” as the preview region 44a. In a case where the preview position information in the preview region setting information is the “photograph portion”, the photograph portion is extracted from the read image of the original document 2. Incidentally, in a case where the reading attribute is “background color removal” and the preview position information is “reading edge”, the edge (for example, lower right) of the read image of the original document 2 is extracted. In a case where a plurality of pieces of preview position information can be extracted, one of the plurality of pieces of preview position information is automatically set.

As already described, in a case where the preview region 44a is set, the preview image generation unit 151 cuts out and extracts the image of the preview region 44a from the captured image of the original document 2, and generates the preview image 46b for each attribute value by any of the two patterns described above. Then, the attribute value selection screen generation unit 122 generates the attribute value selection screen, and the display information generation unit 12 displays the attribute value selection screen shown in FIG. 6 on the operation panel 25 (steps S104 to S107).

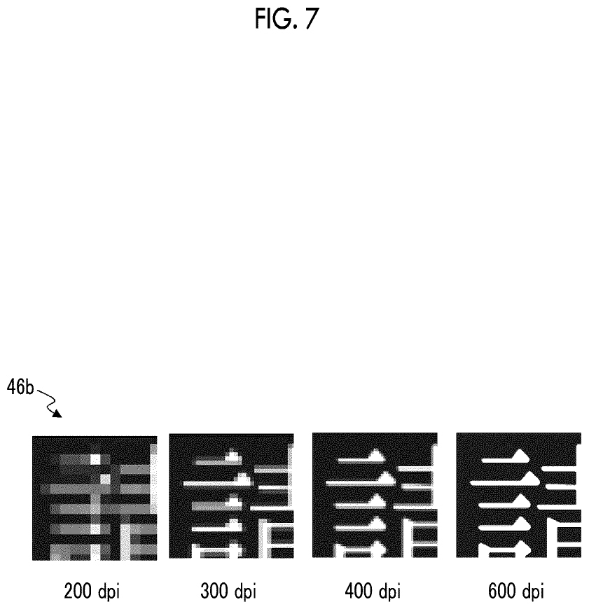

FIG. 7 is a diagram showing a part of “inv” in an enlarged manner for reference such that the difference in the preview image 46b for each attribute value can be understood. The user selects the attribute value of the resolution at which an intended image quality is obtained by an operation of selecting any one of the frames 46a with reference to the preview image 46b. However, for example, the enlarged image shown in FIG. 7 may be displayed in response to an operation of selecting any of the preview images 46b by the user.

The preview image 46b in the relatively small preview region 44a in which the preview range information is “small” may be automatically displayed in an enlarged manner in the frame 46a such that the user can easily check.

In a case where the attribute value is selected by the user, the attribute value setting unit 16 receives the attribute value, sets the received attribute value as the selected reading attribute, in this example, the attribute value of the resolution, and saves the attribute value in the attribute value storage unit 29 (step S110). The control unit 18 proceeds with the processing to step S101 such that the attribute value of the un-set reading attribute can be set.

Incidentally, as described above, the preview region setting unit 13 sets the preview region in accordance with the setting content of the preview region setting information. However, since the content configuration or the importance of the original document 2 is diverse, it is also conceivable that the user may want to check the preview image in a range other than the range defined by the preview region setting information. Therefore, in the present exemplary embodiment, the preview region 44a is displayed on the attribute value selection screen 40 with the setting content in the preview region setting information as the initial setting, and then a preview region different from the initial setting can be set depending on the user's request.

That is, in a case where the preview region 44a that can be checked by the user in the attribute value selection screen 40 may be used (N in step S108), the user may select the attribute value for the reading attribute selected by the user as described above without changing the preview region 44a (step S109).

On the other hand, in a case where the user wants to check the preview image in another part of the original document 2 (Y in step S108), the preview region setting unit 13 moves the position of the current preview region 44a or changes the size of the current preview region 44a in the original document image display region 44. In this case, the user selects, for example, the preview region 44a as an operation target by a touch operation on the operation panel 25, and moves the position of the preview region 44a by a drag operation. Of course, the movable range is in the read image of the original document 2. The user may change the size of the preview region 44a by a pinch-open/pinch-close operation. In this way, in a case where the user sets the preview region 44a at an intended position on the original document 2, the preview region setting unit 13 receives the preview region 44a set by the user (step S111), and specifies the preview region (step S104).

The user interface for allowing the user to set the preview region 44a described here is an example, and the present exemplary embodiment is not limited to this. For example, the original document image display region 44 may be displayed on a screen different from the attribute value selection screen 40 to display the original document image display region 44 in a more enlarged manner to make the user operation easy. In the present exemplary embodiment, the preview region 44a has a square shape, but a function of changing the shape of the preview region 44a may be provided. Further, the original document image display region 44 may be fitted to a coordinate system, and the preview region 44a may be able to be designated by the coordinate value.

As described above, in a case where the position of the preview region 44a displayed in the original document image display region 44 is changed by the user, the preview image generation unit 151 regenerates the preview image corresponding to the preview region 44a of which the position is changed, for each attribute value obtainable for one reading attribute (here, “resolution”) (step S106), the attribute value selection screen generation unit 122 updates the attribute value selection screen 40 by the association with the preview image 46b regenerated in accordance with the attribute value, and the display information generation unit 12 displays the updated attribute value selection screen 40 (step S107).

In the present exemplary embodiment, only one range can be designated as the preview region 44a on the read image of the original document 2, but a plurality of ranges, that is, a plurality of preview regions 44a may be settable.

As described above, in a case where the attribute value is set for the reading attribute that is the processing target, the processing proceeds to step S101, and the user is allowed to select another reading attribute from the attribute item list, so that the user is also allowed to set the attribute value for the other reading attribute in the same manner as described above. In this case, in a case where another reading attribute, for example, “frame erasure” is set, it is desired that the preview image generation unit 151 generates the preview image by using the set attribute value for the preset reading attribute (“resolution” in the above example).

Incidentally, in the reading attributes, there is the reading attribute that allows the user to designate a numerical value, in addition to the reading attribute in which the obtainable reading value, such as “resolution”, is determined and the attribute value can be set by allowing the user to select the attribute value from a plurality of selection candidates. For example, the user is allowed to designate an intended numerical value between 0% and 100%. In this case, the display information generation unit 12 may perform a change to the attribute value selection screen 40 for numerical value designation or prepare a separate attribute value input screen to allow the user to input and designate a numerical value to be an intended attribute value. Alternatively, one or more attribute values may be selected from a range obtainable as the attribute value and selected as candidates for the attribute value obtainable for the typical reading attribute, and the preview image may be generated and displayed for each selected attribute as in the attribute value selection screen 40.

The user performs the processing described above to set the attribute value of the intended reading attribute. In a case where the user does not select the reading attribute from the attribute item list (N in step S103) and performs an operation of selecting a start button for executing the service processing (Y in step S112), the document camera 21, that is, the imaging unit 11 performs the imaging corresponding to the major scanning instead of the pre-scanning (step S113). The imaging unit 11 reads the attribute value of the reading attribute saved in the attribute value storage unit 29, and images the original document 2 in accordance with the attribute value. Of course, as described above, the attribute value that cannot correspond to the imaging such as “frame erasure” is not followed. The read image generation unit 152 generates the read image of the original document 2 from the captured image of the original document 2 (step S114).

In a case where the entire upper surface of the original document table 23 is imaged by the document camera 21, the read image generation unit 152 cuts out and extracts a range in which the original document 2 is imaged, from the captured image as described above, regardless of the set attribute value. The read image generation unit 152 performs the image processing on the captured image of the original document 2 in accordance with the set attribute value. For example, in a case where the resolution is set to 200 dpi, in a case where the imaging is performed at 200 dpi, the resolution may be used without change, but in a case where the imaging is performed at 600 dpi, the read image generation unit 152 performs the image processing to convert the resolution from 600 dpi to 200 dpi. On the other hand, the document camera 21 cannot perform imaging in accordance with the attribute value of the reading attribute such as “background color removal” or “frame erasure”. As described above, the read image generation unit 152 performs the image processing in accordance with the attribute value on the read image of the original document 2 for the reading attribute for which the attribute value cannot be reflected by the imaging.

In the present exemplary embodiment, in a case of setting the attribute value of another reading attribute, for the set reading attribute, the set attribute value is reflected and the preview image is generated. However, it can be assumed that the user may want to change the set attribute value as a result of referring to the preview image. Therefore, a function of changing the attribute value stored in the attribute value storage unit 29 may be provided.

In the present exemplary embodiment, as described above, the attribute value is set for each reading attribute selected by the user, and thus it is not necessary to generate a large number of preview images based on the combination of the attribute values of a plurality of reading attributes. Further, since the preview image is generated only for the partial region (above-described “preview region”) including the position on the original document 2 at which the difference is likely to appear depending on the attribute value obtainable for the one reading attribute, the efficiency is high.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

An image processing system comprising:
an imaging unit; and
a processor,
wherein the processor is configured to:
   display a list of reading attributes set in a case where a read image of an original document is generated in response to a user operation;
   specify, as a preview region, a partial region on the original document that is a generation range of a preview image of the original document in a case where one reading attribute is selected from the list of reading attributes by a user;
   generate the preview image corresponding to the preview region for each attribute value obtainable for the one reading attribute from a captured image of the original document captured by the imaging unit;
   display an attribute value selection screen showing an association between each attribute value obtainable for the one reading attribute and the preview image generated in accordance with the attribute value; and
   set an attribute value selected from the attribute value selection screen by the user as an attribute value of the one reading attribute in a case where the read image of the original document is generated.
      (((2)))

The image processing system according to (((1))), wherein the processor is configured to:
specify, as the preview region, a partial region including a position on the original document at which a difference is likely to appear depending on the attribute value obtainable for the one reading attribute.
   (((3)))

The image processing system according to (((2))), wherein the processor is configured to:
specify the preview region with reference to preview region setting information in which position information indicating the position on the original document at which the difference is likely to appear depending on the attribute value obtainable for the reading attribute, and range information indicating a size of the preview region are associated with a reading attribute settable for the original document.
   (((4)))

The image processing system according to (((2))), wherein the processor is configured to:
display a preview region check screen indicating a position of the preview region on the captured image of the original document.
   (((5)))

The image processing system according to (((4))), wherein the processor is configured to:
in a case where the position of the preview region displayed on the preview region check screen is changed by the user, regenerate the preview image corresponding to the preview region of which the position is changed, for each attribute value obtainable for the one reading attribute; and
update the attribute value selection screen by associating each attribute value obtainable for the one reading attribute with the preview image regenerated in accordance with the attribute value.
   (((6)))

The image processing system according to any one of (((1))) to (((5))), wherein the processor is configured to:
cause the imaging unit to generate one captured image by one imaging; and
generate the preview image corresponding to the attribute value by performing image processing in accordance with each attribute value obtainable for the one reading attribute on the one captured image.
   (((7)))

The image processing system according to (((6))), wherein the processor is configured to:
in a case where the imaging unit is capable of generating the captured image in accordance with the attribute value obtainable for the one reading attribute, cause the imaging unit to generate the captured image corresponding to the attribute value; and
generate the preview image corresponding to the attribute value from the captured image corresponding to the attribute value.
   (((8)))

The image processing system according to any one of (((1))) to (((7))), wherein the processor is configured to:
generate the preview image by using the attribute value of the reading attribute set by the user.
   (((9)))

A program causing a computer to realize:
a function of displaying a list of reading attributes set in a case where a read image of an original document is generated in response to a user operation;
a function of specifying, as a preview region, a partial region on the original document that is a generation range of a preview image of the original document in a case where one reading attribute is selected from the list of reading attributes by a user;
a function of generating the preview image corresponding to the preview region for each attribute value obtainable for the one reading attribute from a captured image of the original document captured by an imaging unit;
a function of displaying an attribute value selection screen showing an association between each attribute value obtainable for the one reading attribute and the preview image generated in accordance with the attribute value; and
a function of setting an attribute value selected from the attribute value selection screen by the user as an attribute value of the one reading attribute in a case where the read image of the original document is generated.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing system comprising:
an imaging unit; and
a processor,
wherein the processor is configured to:
display a list of reading attributes set in a case where a read image of an original document is generated in response to a user operation;
specify, as a preview region, a partial region on the original document that is a generation range of a preview image of the original document in a case where one reading attribute is selected from the list of reading attributes by a user;
generate the preview image corresponding to the preview region for each attribute value obtainable for the one reading attribute from a captured image of the original document captured by the imaging unit;
display an attribute value selection screen showing an association between each attribute value obtainable for the one reading attribute and the preview image generated in accordance with the attribute value; and
set an attribute value selected from the attribute value selection screen by the user as an attribute value of the one reading attribute in a case where the read image of the original document is generated.

2. The image processing system according to claim 1, wherein the processor is configured to:
specify, as the preview region, a partial region including a position on the original document at which a difference is likely to appear depending on the attribute value obtainable for the one reading attribute.

3. The image processing system according to claim 2, wherein the processor is configured to:
specify the preview region with reference to preview region setting information in which position information indicating the position on the original document at which the difference is likely to appear depending on the attribute value obtainable for the reading attribute, and range information indicating a size of the preview region are associated with a reading attribute settable for the original document.

4. The image processing system according to claim 2, wherein the processor is configured to:
display a preview region check screen indicating a position of the preview region on the captured image of the original document.

5. The image processing system according to claim 4, wherein the processor is configured to:
in a case where the position of the preview region displayed on the preview region check screen is changed by the user, regenerate the preview image corresponding to the preview region of which the position is changed, for each attribute value obtainable for the one reading attribute; and
update the attribute value selection screen by associating each attribute value obtainable for the one reading attribute with the preview image regenerated in accordance with the attribute value.

6. The image processing system according to claim 1, wherein the processor is configured to:
cause the imaging unit to generate one captured image by one imaging; and
generate the preview image corresponding to the attribute value by performing image processing in accordance with each attribute value obtainable for the one reading attribute on the one captured image.

7. The image processing system according to claim 6, wherein the processor is configured to:
in a case where the imaging unit is capable of generating the captured image in accordance with the attribute value obtainable for the one reading attribute, cause the imaging unit to generate the captured image corresponding to the attribute value; and
generate the preview image corresponding to the attribute value from the captured image corresponding to the attribute value.

8. The image processing system according to claim 1, wherein the processor is configured to:
generate the preview image by using the attribute value of the reading attribute set by the user.

9. A non-transitory computer readable medium storing a program causing a computer to realize:
a function of displaying a list of reading attributes set in a case where a read image of an original document is generated in response to a user operation;
a function of specifying, as a preview region, a partial region on the original document that is a generation range of a preview image of the original document in a case where one reading attribute is selected from the list of reading attributes by a user;
a function of generating the preview image corresponding to the preview region for each attribute value obtainable for the one reading attribute from a captured image of the original document captured by an imaging unit;
a function of displaying an attribute value selection screen showing an association between each attribute value obtainable for the one reading attribute and the preview image generated in accordance with the attribute value; and
a function of setting an attribute value selected from the attribute value selection screen by the user as an attribute value of the one reading attribute in a case where the read image of the original document is generated.

10. An image processing method comprising:
displaying a list of reading attributes set in a case where a read image of an original document is generated in response to a user operation;
specifying, as a preview region, a partial region on the original document that is a generation range of a preview image of the original document in a case where one reading attribute is selected from the list of reading attributes by a user;
generating the preview image corresponding to the preview region for each attribute value obtainable for the one reading attribute from a captured image of the original document captured by an imaging unit;
displaying an attribute value selection screen showing an association between each attribute value obtainable for the one reading attribute and the preview image generated in accordance with the attribute value; and
setting an attribute value selected from the attribute value selection screen by the user as an attribute value of the one reading attribute in a case where the read image of the original document is generated.
